(19) United States
(12) Patent Application Publication
(10) Pub. No.: US 2022/0131711 A1
(43) Pub. Date: Apr. 28, 2022

(54) PROVIDING NOTIFICATION OF A CERTIFICATE OF VALIDITY TO A SERVICE PROVIDER

(71) Applicant: ARRIS Enterprises LLC, Suwanee, GA (US)

(72) Inventors: Vinod JATTI, Bangalore (IN); William P. FRANKS, San Diego, CA (US)

(73) Assignee: ARRIS Enterprises LLC, Suwanee, GA (US)

(21) Appl. No.: 17/496,379

(22) Filed: Oct. 7, 2021

Related U.S. Application Data
(60) Provisional application No. 63/106,086, filed on Oct. 27, 2020.

(51) Int. Cl. H04L 9/32

(52) U.S. Cl. CPC H04L 9/3268

(57) ABSTRACT

A media control device manages one or more digital certificates that may be related to communication of electronic content. An expiration date may be identified of at least one digital certificate. A validity time period may be identified of the at least one digital certificate. The validity time period may be based, at least in part, on a comparison between the expiration date and a target date. An expiration status of the at least one digital certificate may be determined. The expiration status may be negative when the validity time period is greater than a predetermined time period. The expiration status may be positive when the validity time period is less than, or equal to, the predetermined time period. An electronic notification indicating the expiration status for the at least one digital certificate may be sent when the expiration status is positive.

### BACKGROUND

Media content may be provided by a plurality of media content network operators to home and/or business subscribers/viewers. Media content network operators (e.g., cable network operators, or satellite operators, etc.) may provide subscribers/viewers with various forms of media content, such as movies, concerts, premium media content, broadcast media content, and/or pay-per-view (PPV) media content, and/or the like.

More generally, various kinds of electronic documents, in addition to media content, may be received, transmitted, and/or transferred, perhaps for example via networks, websites, and/or Internet-based computing devices, etc. Communication through such networks, websites, and/or Internet-based computing devices may be facilitated by media content network operators, Internet Service Providers (ISPs), and/or one or more specific business entities, etc., for example.

For various reasons, the electronic content (e.g., media content, electronic documents, device-to-device communications, electronic communications, electronic services, among other types of electronic content) may require encryption. While there are different types of encryption techniques, at least some encryption techniques may utilize a digital certificate that may provide a (e.g., satisfactory) level of authenticated verification by a trusted party of an entity's identity that is publishing an encryption public key as part of an asymmetrical encryption technique, among other encryption techniques.

### SUMMARY

Technologies are disclosed for managing one or more digital certificates that may be related to communication of electronic content via a media control device, for example, among other devices. The media control device may be a set-top box, a home gateway, a mobile device, a media gateway, a television, and/or a personal computing device, among others, for example.

The device may identify an expiration date (e.g., a first expiration date) (e.g., in electronic form) of at least one digital certificate (e.g., a first digital certificate) of the one or more digital certificates. The device may identify a validity time period (e.g., a first validity time period) (e.g., in electronic form) of the at least first digital certificate. The first validity time period may be based, at least in part, on a comparison between the first expiration date and a target date. The device may identify expiration status of the at least first digital certificate.

In one or more scenarios, the first expiration status may be negative, for example, where the first validity time period is greater than a predetermined time period. The first expiration status may be positive, for example, where the first validity time period is less than, or equal to, the predetermined time period.

In one or more scenarios, the device may send a first electronic notification indicating the first expiration status for the at least first digital certificate, among other information, perhaps for example when the first expiration status is positive.

In one or more scenarios, the device may identify a start date (e.g., in electronic form) of the at least first digital certificate. The device may identify a certificate name (e.g., in electronic form) that may be associated with at least first digital certificate. The device may identify a model number (e.g., in electronic form) that may be associated with the device, and/or a product name (e.g., in electronic form) that may be associated with the device. The device may identify a unique identifier (e.g., in electronic form) that may be associated with the device. The first electronic notification may indicate the start date, the certificate name, the model number, the product name, and/or the unique identifier.

In one or more scenarios, the device may be in communication with a network services provider. The first electronic notification may be sent a server device operated by the network services provider, or a manufacturer of the media control device for example.

In one or more scenarios, the device may automatically perform any or all of the subject matter described herein at least once in a predetermined time frequency, for example. The predetermined time frequency may be weekly, bi-weekly, monthly, annually, semi-annually, and/or bi-annually, among other frequencies.

In one or more scenarios, the device may receive an input. The device may initiate performance of any or all of the subject matter described herein at least once, for example at a time proximate to receipt of the input.

In one or more scenarios, the device may be in communication with a network services provider. The device may generate and/or update a database. The database may include one or more entries corresponding to at least some of the one or more digital certificates. The database may include the first expiration date, the start date, the target date, the certificate name, the first validity time period, the predetermined time period, the model number, the product name, the unique identifier, and/or the first expiration status. The database may be located on the device, and/or a server device that may be operated by the network services provider, for example.

In one or more scenarios, the device may receive an input indicating the target date. The predetermined time period may be a week, a month, three months, six months, nine months, and/or twelve months, for example.

In one or more scenarios, the device may be in communication with a network services provider. The device may be a first device that may establish communication with a second media control device. The second device may be served by the network services provider. The first device may identify an expiration date (e.g., a second expiration date) (e.g., in electronic form) of at least a second digital certificate of one or more digital certificates that may be related to communication of electronic content via the second device.

In one or more scenarios, the first device may identify a second validity time period (e.g., in electronic form) of the at least second digital certificate. The second validity time period may be based, at least in part, on a comparison between the second expiration date and the target date, for example.

In one or more scenarios, the first device may identify a second expiration status of the at least second digital certificate. The second expiration status may be negative, for example where the second validity time period is greater than the predetermined time period. The second expiration status may be positive where the second validity time period is less than, or equal to, the predetermined time period.

In one or more scenarios, the first device may send a second electronic notification indicating at least the second expiration status for the at least second digital certificate, among other information, perhaps for example where the second expiration status is positive.

### BRIEF DESCRIPTION OF DRAWINGS

The elements and other features, advantages and disclosures contained herein, and the manner of attaining them, will become apparent and the present disclosure will be better understood by reference to the following description of various examples of the present disclosure taken in conjunction with the accompanying drawings, wherein:

FIG. 1 is a block diagram illustrating an example network environment operable to deliver electronic content throughout the network via one or more network devices, such as a consumer premises device (CPE) device, among other devices.

FIG. 2 is a block diagram illustrating an example CPE device of FIG. 1 that may be configured to deliver electronic content to a subscriber.

FIG. 3 is an example flow diagram of at least one technique for managing one or more digital certificates.

FIG. 4 is a block diagram of a hardware configuration of an example device that may deliver electronic content, such as the CPE device of FIG. 2.

FIG. 5 is a block diagram of a hardware configuration of an example device that may deliver electronic content, such as a home gateway.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of this disclosure is thereby intended.

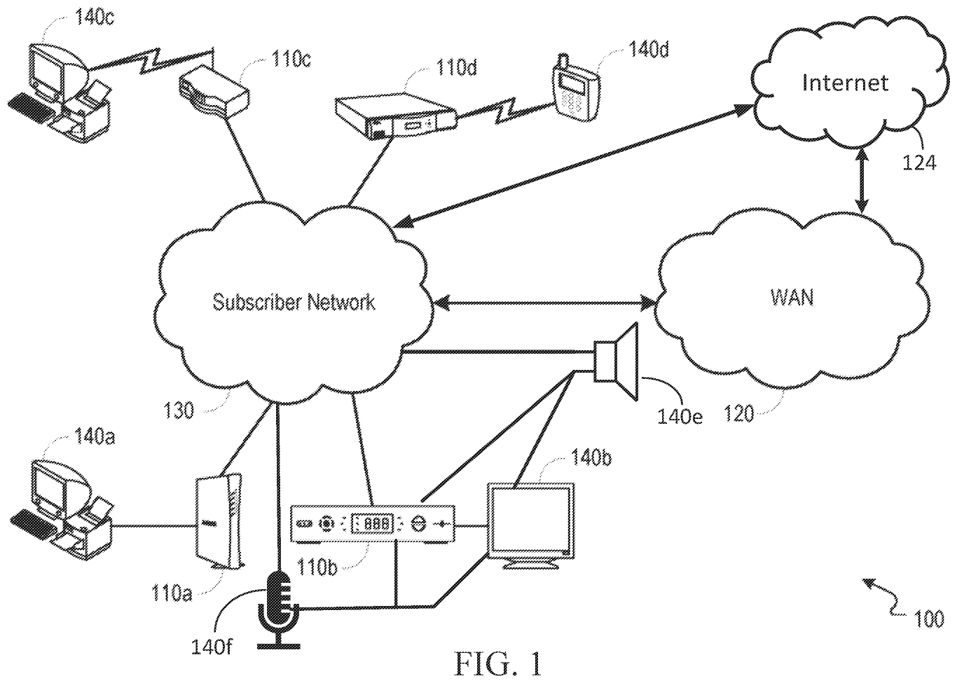

FIG. 1 is a block diagram illustrating an example network environment 100 operable for electronic content delivery. Electronic content may include media content, electronic documents, device-to-device communications, Internet/cloud-based electronic applications/services/databases, electronic communications/services, Internet-based electronic services, electronic commerce, video components/elements of electronic content, and/or audio components/elements of electronic content, among other types of electronic content.

A media content delivery network operator, or MSO, may deliver media content to subscribers/viewers. Media content may be provided via a consumer premise equipment (CPE) and/or network gateway device supported by the MSO, for example. In one or more scenarios, CPE devices 110a-d receive video service(s) and/or data service(s) from a wide area network (WAN) 120 via a connection to a subscriber network 130. The one or more nodes of subscriber network 130 and/or the WAN 120 may communicate with one or more cloud-based nodes (not shown) via the Internet 124. The subscriber network 130 and/or WAN 120 may include a home gateway (not shown), that may be used to implement set-top box functionality, among other functions.

The CPE devices can include, for example, a modem 110a, a set-top box 110b, a wireless router including an embedded modem 110c, or a media gateway 110d, among many others (e.g., digital subscriber line (DSL) modem, voice over internet protocol (VOIP) terminal adapter, video game console, digital versatile disc (DVD) player, communications device, hotspot device, etc.). The subscriber network 130, for example, can be a hybrid fiber-coaxial (HFC) network, a local area network (LAN), a wireless local area network (WLAN), a cellular network, a personal area network (PAN), as well as others.

The CPE devices can facilitate communications between the WAN 120 and client devices 140a-f. A cable modem or embedded MTA (eMTA) 110a can facilitate communications between the WAN 120 and a computer 140a. A set-top box 110b can facilitate communications between the WAN 120 and a television/monitor 140b (e.g., a media presentation device) and/or a digital video recorder (DVR). A wireless router 110c can facilitate communications between a computer 140c and the WAN 120. The media gateway 110d can facilitate communications between a mobile device 140d (e.g., a tablet computing device, a smartphone, a personal digital assistant (PDA) device, a laptop computing device, etc.; one or more devices being PC-based, iOS-based, Linux-based, and/or Android-based, etc.) and the WAN 120. One or more speaker devices (e.g., sound radiation devices/systems) 140e may be in communication with the Subscriber Network 130, set-top box 110b, and/or television 140b, etc.

The one or more speaker devices 140e (e.g., surround sound speakers, home theater speakers, other external wired/wireless speakers, loudspeakers, full-range drivers, subwoofers, woofers, mid-range drivers, tweeters, coaxial drivers, etc.) may broadcast at least an audio component of electronic content/media content, among other audio signals/processes/applications. The one or more speaker devices 140e may possess the capability to radiate sound in pre-configured acoustical/physical patterns (e.g., a cone pattern, a directional pattern, etc.)

One or more microphone devices 140f may be external/standalone microphone devices. The one or more microphone devices 140f may be in communication with the Subscriber Network 130, set-top box 110b, and/or television 140b, etc. Any of the client devices 140a-e may include internal microphone devices. The one or more speaker devices 140e (e.g., “speakers”) and/or the one or more microphone devices 140f (e.g., “microphones”) may have wired and/or wireless connections (e.g., Bluetooth, Wi-Fi, private protocol communication network, etc.) to any of the other devices 140a-140d, the Subscriber Network 130, the WAN 120, and/or the Internet 124.

A user (not shown) may monitor (e.g., watch and/or listen to) media content and/or more generally interact with various kinds of electronic content on/from/via one or more of the devices 110a-110d and/or 140a-140d, among other devices (not shown), for example. The electronic content may be encrypted via one or more encryption techniques, such as symmetrical and/or asymmetrical encryption. Any of the devices 110a-110d and/or 140a-140d may utilize one or more digital certificates to initiate, and/or engage in, encrypted communication to obtain, interact, and/or monitor electronic content that may be conveyed via the Internet 124, the WAN 120, and/or the Subscriber Network 130, etc., for example.

For example, a digital certificate may include (e.g., in electronic form, text form, and/or alpha-numeric form, etc.) an identification (e.g., name) of the business or individual providing the public encryption key (e.g., entity to whom the digital certificate is issued), the public encryption key, a start date of the digital certificate, an expiration date of the digital certificate, an identification (e.g., name) of the (e.g., trusted-party) issuer of the digital certificate, a name of the digital certificate, a subject matter of the digital certificate, a certification path/root directory of the digital certificate, a status (e.g., an operation status) of the digital certificate, a purpose of the digital certificate, a version identifier of the digital certificate, a unique identifier (e.g. a serial number) of the digital certificate, a signature algorithm of the digital certificate, and/or a signature hash algorithm of the digital certificate, among other information.

In one or more scenarios, an expiration of one or more digital certificates could result in service interruptions, for example in the communication of electronic content associated with expired digital certificates. Such service interruptions, perhaps even if relatively short in duration, could cause significant problems (e.g., personal entertainment/business issues, commercial business issues, customer service issues, device manufacturer issues, device-to-device enterprise issues, etc.). For example, electronic content providers and/or electronic content consumers may suffer various kinds of issues/losses if electronic content communication is interrupted due to the expiration of associated digital certificates. The issues/losses may be significant, perhaps for example if the expired digital certificates are associated with critical use case-type electronic content, among other kinds of electronic content.

In one or more scenarios, expired digital certificate may cause errors when communication of associated electronic content is attempted. For example, one or more error codes may be generated and/or displayed where/when a digital certificate may be expired. Such error codes may result from the expiration of a digital rights management (DRM) certificate (e.g., a digital certificate), or the like, for example.

Stated somewhat differently, a digital certificate is an electronic document that may be used to prove the ownership of a public encryption key. A digital certificate may include information about the key, a digital signature of an entity that has verified the digital certificate's contents (e.g., the digital certificate issuer). Perhaps for example if the digital signature is valid and/or the software examining the digital certificate trusts the issuer, then the software can use that public encryption key to communicate (e.g., securely) with the certificate's subject. One or more consumer electronic devices, such as any of the devices 110a-110d and/or 140a-140d may comprise, use, and/or access one or more digital certificates, perhaps for example for various types of use cases.

Digital certificates may have corresponding validity time periods (e.g., the time period between the start date and the end/expiration date), beyond which the digital certificates may be expired and/or might not be valid. Validity time periods may vary, for example from relatively short durations (e.g., six months, one year, etc.) to relatively long durations (e.g., ten years, twenty-five years, etc.). When digital certificates expire, such expirations usually negatively impact and/or stop electronic content functions/use cases associated with the expired digital certificates.

Using current methods and/or devices, network services providers and/or media control device manufacturers might not be able to correlate if electronic content consumer/customer reported problems may be related to expired digital certificates. Technologies that may track (e.g., detect and/or notify, etc.) digital certificates and at least their expiration dates for various devices may be useful. Capabilities, techniques, methods, and/or devices described herein may at least facilitate the tracking and/or upgrading/updating/renewal of digital certificates before their expiration, for example.

The WAN network 120 and/or the subscriber network 130 may be implemented as any type of wired and/or wireless network, including a local area network (LAN), a wide area network (WAN), a global network (the Internet), etc. Accordingly, the WAN network 120 and/or the subscriber network 130 may include one or more communicatively coupled network computing devices (not shown) for facilitating the flow and/or processing of network communication traffic via a series of wired and/or wireless interconnects. Such network computing devices may include, but are not limited, to one or more access points, routers, switches, servers, computing devices, and/or storage devices, etc.

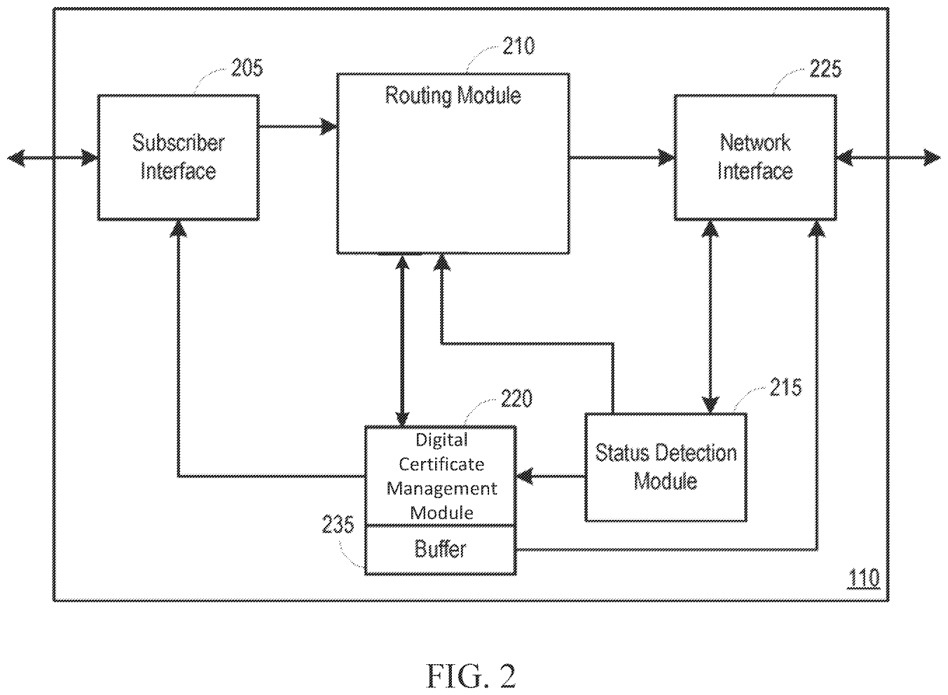

FIG. 2 is a block diagram illustrating an example CPE device 110 (e.g., any of the devices 110a-110d) operable to output audio/visual electronic content/media content to one or more devices, such as for example, the television/monitor 140b, mobile device 140d, computer 140c, computer 140a, one or more speaker devices 140e, and/or one or more microphone devices 140f, etc. The CPE device 110 can include a subscriber interface 205, a routing module 210, a status detection module 215, a digital certificate management module 220, and/or a network interface 225.

In one or more scenarios, the CPE device 110 may receive a communication from a subscriber or subscriber device (e.g., subscriber device 140a-f of FIG. 1). For example, the communication can be a request for data and/or a service from a network (e.g., WAN 120 of FIG. 1). A communication received from a subscriber or subscriber device can be received as a resource identifier (e.g., URL, and/or an IP address, and/or other format).

In one or more scenarios, a routing module 210 may route a received communication to a network interface 225. The routing module 210 may route the communication to the network interface 225. The routing module may translate the received communication from a URL to an IP address.

In one or more scenarios, a media control device (e.g., set-top box 110b and/or any of the devices 110a-110d and/or 140a-140b) and/or its digital certificate management module 220 may be configured to manage one or more digital certificates using the subject matter described herein. The one or more digital certificates may be related to communication of electronic content via the media control device, for example.

In one or more scenarios, the digital certificate management module 220 may be configured to identify an expiration date (e.g., a first expiration date) (e.g., in electronic form, etc.) of at least a first digital certificate of the one or more digital certificates. A first validity time period (e.g., in electronic form, etc.) of the at least first digital certificate may be identified. The first validity time period may be based, at least in part, on a comparison between the expiration date and a target date/reference date.

In one or more scenarios, the target date/reference date may be a present date and/or one or more reference dates of interest (e.g., a close of a business fiscal year, a licensing services audit date, etc.). The target date/reference date may be input by an operator/manufacturer of the media control device and/or a network services provider, among other scenarios, for example.

In one or more scenarios, the digital certificate management module 220 may be configured to identify a first expiration status of the at least first digital certificate. The first expiration status may be negative, perhaps for example where the first validity time period is greater than a predetermined time period. The first expiration status may be positive, perhaps for example where the first validity time period is less than, or equal to, the predetermined time period.

In one or more scenarios, the predetermined time period may be any time period of interest. For example, the predetermined time period may be a week, a month, three months, six months, nine months, and/or twelve months, among other predetermined time periods.

In one or more scenarios, the digital certificate management module 220 may be configured to send an electronic notification (e.g., a first electronic notification) at least where the first expiration status is positive, among other scenarios. The first electronic notification may indicate the first expiration status for the at least first digital certificate, among other information, for example.

In one or more scenarios, the media control device may be in communication with a network services provider and/or an operator/manufacturer of the media control device. The first electronic notification may be sent to a server device operated by the network services provider, and/or to the operator/manufacturer of the media control device, for example.

In one or more scenarios, the digital certificate management module 220 may be configured to identify a start date (e.g., in electronic form, etc.) of the at least first digital certificate. A certificate name (e.g., in electronic form, etc.) that may be associated with the at least first digital certificate may be identified. The digital certificate management module 220 may be configured to identify a model number (e.g., in electronic form, etc.) that may be associated with the media control device, and/or a product name (e.g., in electronic form) that may be associated with the media control device, for example.

In one or more scenarios, the digital certificate management module 220 may be configured to identify a unique identifier (e.g., in electronic form, etc.) that may be associated with the media control device. The first electronic notification may include the start date, the certificate name, the model number, the product name, and/or the unique identifier, for example.

In one or more scenarios, any or all of the capabilities, techniques, methods, and/or devices described herein regarding digital certificate management may be (e.g., automatically) performed at least once in a predetermined time frequency. For example, the predetermined time frequency may be weekly, bi-weekly, monthly, annually, semi-annually, and/or bi-annually, etc.

In one or more scenarios, the digital certificate management module 220 may be configured to receive an input. The input may correspond to a request to contemporaneously perform any or all of the capabilities, techniques, methods, and/or devices described herein regarding digital certificate management. Performance of any or all of the capabilities, techniques, methods, and/or devices described herein regarding digital certificate management may be initiated at least once at a time proximate to receipt of the input.

In one or more scenarios, the media control device may be in communication with a network services provider. The digital certificate management module 220 may be configured to generate and/or update a database.

In one or more scenarios, the database may include one or more entries that may correspond to at least some of the one or more digital certificates. The database may include one or more of: the first expiration date, the start date, the target date, the certificate name, the first validity time period, the predetermined time period, the model number, the product name, the unique identifier, and/or the first expiration status. The database may be located on the media control device, and/or on a server device operated by the network services provider, among other locations, for example.

In one or more scenarios, the database may include functions and/or use cases (e.g., critical use cases) that may be associated with the at least some of the one or more digital certificates, among other information, for example.

In one or more scenarios, the media control device may be in communication with a network services provider. At times, the media control device may interact with other (e.g., in-home environment and/or business environment) media control devices that may be served by the network services provider. Such other media control devices might not be configured for any or all of the capabilities, techniques, methods, and/or devices described herein regarding digital certificate management. Such other media control devices might not have (e.g., direct) communication with Internet, for example.

In one or more scenarios the media control device may be a “first” media control device. At least one of the other media control devices may be a “second” media control device. The first media control device and/or its digital certificate management module 220 may be configured to establish communication with the second media control device.

In one or more scenarios, the first media control device may identify an expiration date (e.g., a second expiration date) (e.g., in electronic form) of at least a second digital certificate of one or more digital certificates that may be related to communication of electronic content via the second media control device, for example. The first media control device may identify a validity time period (e.g., a second validity time period) (e.g., in electronic form) of the at least second digital certificate. The second validity time period may be based, at least in part, on a comparison between the second expiration date and the target date, for example.

In one or more scenarios, the first media control device may identify an expiration status (e.g., second expiration status) of the at least second digital certificate. The expiration status may be negative, perhaps for example where the second validity time period is greater than the predetermined time period. The second expiration status may be positive, perhaps for example where the second validity time period is less than, or equal to, the predetermined time period, for example.

In one or more scenarios, the first media control device may send a second electronic notification perhaps for example where the expiration status is positive, among other scenarios. The second electronic notification may indicate the second expiration status for the at least second digital certificate, among other information, for example. The second electronic notification may be sent to a server device operated by the network services provider, and/or to the operator/manufacturer of the first media control device and/or the second media control device, for example.

The routing module 210 can route communications, requests, determinations, and/or detections of digital certificate management by/for the digital certificate management module 220. For example, the routing module 210 can translate the communications, requests, determinations, and/or detections of digital certificate management into and/or with an address (e.g., IP address) associated with the digital certificate management module 220. The status detection module 215 may monitor the network connection status of the CPE device 110.

The status detection module 215 may identify the status of the network connection for the CPE device 110. The status detection module 215 can monitor the network connection of the CPE device 110 through the network interface 225. The status detection module 215 can monitor one or more various components that are associated with the network connection for the CPE device 110. For example, the status detection module 215 can monitor one or more hardware components (e.g., internal hardware components of the CPE device 110, connection cables such as radio frequency cables, phone lines, and/or digital subscriber lines, etc.) that may be used in the connection of the CPE device 110 to a network. This may include physical status detection (e.g., physical mapping to signal). Perhaps for example if no signal is detected, a physical component may be broken (e.g., broken line or disconnected plug, etc.), among other potential issues. A prompt can instruct a subscriber to check an associated connector and/or line.

The status detection module 215 can monitor the status of the network and/or data link layer(s) associated with the CPE device 110. For example, the status detection module 215 can monitor the CPE device's 110 connection to a host server (e.g., dynamic host configuration protocol server) and/or the status of configuration information received from the host server. For example, the status detection module 215 can monitor the CPE device's 110 connection to a packet routing server (e.g., a point-to-point protocol PPP server) and/or subscriber credentials such as a username and password associated with the packet routing server. Data link layer status may include failed (synchronization failure), connected, on-doing/on-going (synchronizing), and/or others. Perhaps for example in response to a failure, among other scenarios, a re-scan for a cable line and/or retraining for DSL line may be attempted.

The communications, requests, determinations, and/or detections of digital certificate management may be transmitted and/or stored in one or more files, such as text files (e.g., Hypertext Transfer Protocol (HTTP) files), among other type of files.

The CPE device 110 may store one or more, or multiple, files that may be ordered (e.g., hierarchically according to a specific order) for carrying out one or more actions in the setup of a device (e.g., set-top box 110b). The digital certificate management module 220 may include and/or be in communication with a buffer 235. The buffer 235 can store a subscriber communication (e.g., URL or IP address received from the subscriber) and/or the communications, requests, determinations, and/or detections of digital certificate management. In one or more scenarios, perhaps for example when the status detection module 215 may determine that a network connection issue might no longer exist, the buffer 235 can output the subscriber communication and/or the communications, requests, determinations, and/or detections of digital certificate management through the network interface 225.

In one or more scenarios, media content elements of the electronic content may include one or more of over-the-top (OTT) video, cable video, broadcast video, and/or satellite video, among other types of video content.

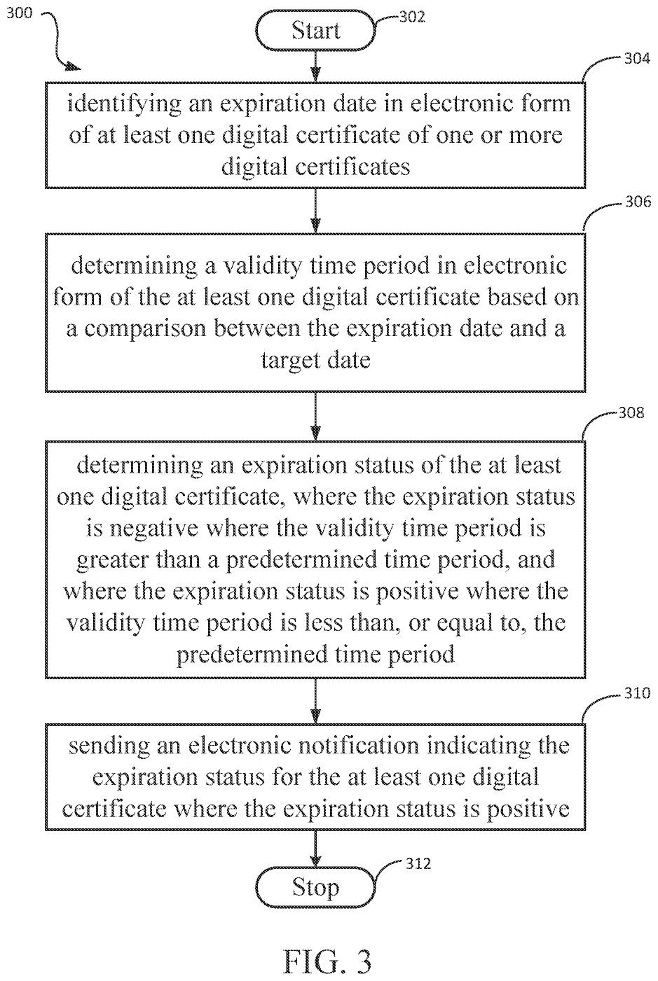

Referring now to FIG. 3, an example diagram 300 illustrates a technique for managing one or more digital certificates related to communication of electronic content via a media control device, among other devices. For example, the media control device may be a set-top box such as device 110b, among other devices 110a-110d and/or 140a-140d. The media control device may be in communication with at least one network services provider. At 302, the process may start. At 304, the media control device may identify an expiration date (e.g., a first expiration date) (e.g., in electronic form) of at least a first digital certificate of the one or more digital certificates.

At 306, the media control device may identify a validity time period (e.g., a first validity time period) (e.g., in electronic form) of the at least first digital certificate. The first validity time period may be based, at least in part, on a comparison between the first expiration date and a target date. In one or more scenarios, the target date may be a present date and/or one or more reference dates of interest (e.g., a close of a business fiscal year, a licensing services audit date, etc.). The target date may be input by an operator/manufacturer of the media control device and/or a network services provider, among other scenarios, for example.

At 308, an expiration status (e.g., a first expiration status) of the at least first digital certificate may be identified. The first expiration status may be negative perhaps for example where the first validity time period may be greater than a predetermined time period. The predetermined time period may be a week, a month, three months, six months, and/or twelve months, etc. The first expiration status may be positive perhaps for example where the first validity time period may be less than, or equal to, the predetermined time period.

At 310 an electronic notification (e.g., a first electronic notification) may be sent. The first electronic notification may indicate at least the first expiration status for the at least first digital certificate, perhaps for example at least where the first expiration status is positive, among other scenarios.

At 312 the process may stop or restart. In one or more scenarios, the media control device may be a set-top box, a mobile device, a television, a personal computing device, a home gateway, and/or a media gateway, among other devices.

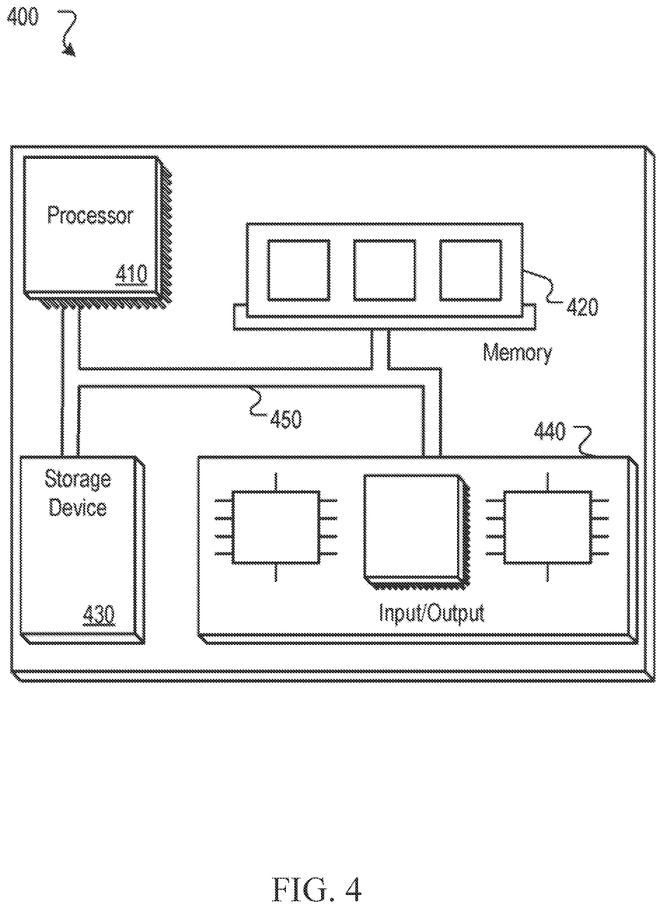

FIG. 4 is a block diagram of a hardware configuration of an example device that may deliver electronic content/media content (e.g., video and/or audio content/components of electronic content), such as the CPE device 110 of FIG. 2, among other devices such as 140a-140d and/or 110a-110b, for example. The hardware configuration 400 may be operable to facilitate delivery of information from an internal server of a device. The hardware configuration 400 can include a processor 410, a memory 420, a storage device 430, and/or an input/output device 440. One or more of the components 410, 420, 430, and 440 can, for example, be interconnected using a system bus 450. The processor 410 can process instructions for execution within the hardware configuration 400. The processor 410 can be a single-threaded processor or the processor 410 can be a multi-threaded processor. The processor 410 can be capable of processing instructions stored in the memory 420 and/or on the storage device 430.

The memory 420 can store information within the hardware configuration 400. The memory 420 can be a computer-readable medium (CRM), for example, a non-transitory CRM. The memory 420 can be a volatile memory unit, and/or can be a non-volatile memory unit.

The storage device 430 can be capable of providing mass storage for the hardware configuration 400. The storage device 430 can be a computer-readable medium (CRM), for example, a non-transitory CRM. The storage device 430 can, for example, include a hard disk device, an optical disk device, flash memory and/or some other large capacity storage device. The storage device 430 can be a device external to the hardware configuration 400.

The input/output device 440 may provide input/output operations for the hardware configuration 400. The input/output device 440 (e.g., a transceiver device) can include one or more of a network interface device (e.g., an Ethernet card), a serial communication device (e.g., an RS-232 port), one or more universal serial bus (USB) interfaces (e.g., a USB 2.0 port) and/or a wireless interface device (e.g., an 802.11 card). The input/output device can include driver devices configured to send communications to, and/or receive communications from one or more networks (e.g., subscriber network 120 of FIG. 1).

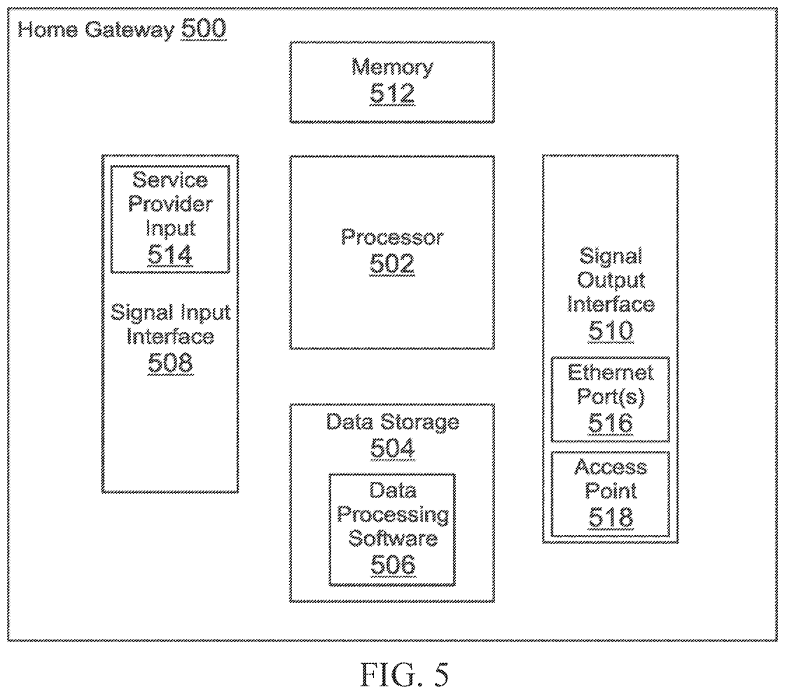

FIG. 5 is a block diagram of a hardware configuration of an example device that may deliver electronic content/media content (e.g., video and/or audio components of electronic content), such as a home gateway (e.g., an access point device), among other devices. A hardware configuration 500 (e.g., home gateway 500) may be constructed in a similar manner to hardware configuration 400 in that the architecture may be built around a general-purpose processor, processor 502, and/or an application specific chip set such as designed for use in a Data Over Cable Service Interface Specification (DOCSIS), a Gigabit Passive Optical Network (GPON), and/or a Digital Subscriber Line (DSL) modem. As with processor 402, the general-purpose processor 502 may also be an off-the-shelf processor. The functionality of the desired modem may be implemented through data processing software 506 stored in data storage 504 and/or may be run on processor 502.

Home gateway 500 may include signal input interface 508 and/or signal output interface 510. Signal input interface 508 may include, for example, circuitry to receive data input from a service provider at service provider input 514, e.g., a cable and/or a fiber optic input.

Signal output interface 510 may provide the output of the home gateway 500. Signal output interface 510 may provide signals in formats for transmission over a datalink. For example, interface 510 may include one or more Ethernet ports 516 and/or a wireless access point 518. Data may be communicated over wired and/or wireless networks. The access point 518 may be located external to the home gateway 500. Video and/or audio content received at signal input interface 508 can be streamed from home gateway 500 to hardware configuration 400, perhaps for example as another source of video and/or audio signal. This streaming may be accomplished over a reliable backhaul communication link (not shown) that may provide good video quality, perhaps for example for signals that are sensitive to latency in the signal (e.g., live programming). The signal input interface 508 and the signal output interface 510 may operate together, such as for example as a transceiver device.

In operation, a data signal may be received at signal input interface 508 of home gateway 500. Processor 502 may operate data processing software 506 on general-purpose processor 502 to prepare the received signals (e.g., code, decode, etc.). The output of the data processing software 506 may be output by signal output interface 510, e.g., Ethernet port 516 and/or wireless access point 518.

Those skilled in the art will appreciate that the disclosed subject matter improves upon methods and/or apparatuses for managing one or more digital certificates of one or more providers of encrypted electronic content. For example, proper management may provide for timely updating of the one or more digital certificates before the one or more certificates expire. Expired digital certificates can cause many issues, such as but not limited to, disruption of communication of electronic content. This may be useful in one or more scenarios, for example where a network services provider and/or a networked device owner/operator may have a relatively large number of digital certificates to manage and/or maintain, among other scenarios.

The subject matter of this disclosure, and components thereof, can be realized by instructions that upon execution cause one or more processing devices to carry out the processes and/or functions described herein. Such instructions can, for example, comprise interpreted instructions, such as script instructions, e.g., JavaScript or ECMAScript instructions, or executable code, and/or other instructions stored in a computer readable medium.

Implementations of the subject matter and/or the functional operations described in this specification and/or the accompanying figures can be provided in digital electronic circuitry, in computer software, firmware, and/or hardware, including the structures disclosed in this specification and their structural equivalents, and/or in combinations of one or more of them. The subject matter described in this specification can be implemented as one or more computer program products, e.g., one or more modules of computer program instructions encoded on a tangible program carrier for execution by, and/or to control the operation of, data processing apparatus.

A computer program (also known as a program, software, software application, script, or code) can be written in any form of programming language, including compiled or interpreted languages, and/or declarative or procedural languages. It can be deployed in any form, including as a stand-alone program or as a module, component, subroutine, and/or other unit suitable for use in a computing environment. A computer program may or might not correspond to a file in a file system. A program can be stored in a portion of a file that holds other programs and/or data (e.g., one or more scripts stored in a markup language document), in a single file dedicated to the program in question, and/or in multiple coordinated files (e.g., files that store one or more modules, sub programs, or portions of code). A computer program can be deployed to be executed on one computer or on multiple computers that may be located at one site or distributed across multiple sites and/or interconnected by a communication network.

The processes and/or logic flows described in this specification and/or in the accompanying figures may be performed by one or more programmable processors executing one or more computer programs to perform functions by operating on input data and/or generating output, thereby tying the process to a particular machine (e.g., a machine programmed to perform the processes described herein). The processes and/or logic flows can also be performed by, and apparatus can also be implemented as, special purpose logic circuitry, e.g., an FPGA (field programmable gate array) and/or an ASIC (application specific integrated circuit).

Computer readable media suitable for storing computer program instructions and/or data may include all forms of non-volatile memory, media and memory devices, including by way of example semiconductor memory devices (e.g., EPROM, EEPROM, and/or flash memory devices); magnetic disks (e.g., internal hard disks or removable disks); magneto optical disks; and/or CD ROM and DVD ROM disks. The processor and/or the memory can be supplemented by, or incorporated in, special purpose logic circuitry.

While this specification and the accompanying figures contain many specific implementation details, these should not be construed as limitations on the scope of any invention and/or of what may be claimed, but rather as descriptions of features that may be specific to described example implementations. Certain features that are described in this specification in the context of separate implementations can also be implemented in combination in perhaps one implementation. Various features that are described in the context of perhaps one implementation can also be implemented in multiple combinations separately or in any suitable sub-combination. Although features may be described above as acting in certain combinations and/or perhaps even (e.g., initially) claimed as such, one or more features from a claimed combination can in some cases be excised from the combination. The claimed combination may be directed to a sub-combination and/or variation of a sub-combination.

While operations may be depicted in the drawings in an order, this should not be understood as requiring that such operations be performed in the particular order shown and/or in sequential order, and/or that all illustrated operations be performed, to achieve useful outcomes. The described program components and/or systems can generally be integrated together in a single software product and/or packaged into multiple software products.

Examples of the subject matter described in this specification have been described. The actions recited in the claims can be performed in a different order and still achieve useful outcomes, unless expressly noted otherwise. For example, the processes depicted in the accompanying figures do not require the particular order shown, and/or sequential order, to achieve useful outcomes. Multitasking and parallel processing may be advantageous in one or more scenarios.

While the present disclosure has been illustrated and described in detail in the drawings and foregoing description, the same is to be considered as illustrative and not restrictive in character, it being understood that only certain examples have been shown and described, and that all changes and modifications that come within the spirit of the present disclosure are desired to be protected.

What is claimed is:

1. A method for managing one or more digital certificates related to communication of electronic content via a media control device, the method comprising:
identifying, by the media control device, a first expiration date in electronic form of at least a first digital certificate of the one or more digital certificates;
identifying, by the media control device, a first validity time period in electronic form of the at least first digital certificate based, at least in part, on a comparison between the first expiration date and a target date;
identifying, by the media control device, a first expiration status of the at least first digital certificate, the first expiration status being negative upon the first validity time period being greater than a predetermined time period, the first expiration status being positive upon the first validity time period being at least one of: less than, or equal to, the predetermined time period; and
sending, by the media control device, a first electronic notification indicating at least the first expiration status for the at least first digital certificate at least upon the first expiration status being positive.

2. The method of claim 1, further comprising:
identifying, by the media control device, a start date in electronic form of the at least first digital certificate;
identifying, by the media control device, a certificate name in electronic form associated with the at least first digital certificate;
identifying, by the media control device, at least one of: a model number in electronic form associated with the media control device, or a product name in electronic form associated with the media control device; and
identifying, by the media control device, a unique identifier in electronic form associated with the media control device, wherein the first electronic notification further indicates at least one of: the start date, the certificate name, the model number, the product name, or the unique identifier.

3. The method of claim 1, wherein the media control device is in communication with a network services provider, and the sending the first electronic notification further comprises:
sending the first electronic notification to at least one of: a server device operated by the network services provider, or a manufacturer of the media control device.

4. The method of claim 1, wherein the method is automatically performed at least once in a predetermined time frequency, the predetermined time frequency being at least one of: weekly, bi-weekly, monthly, annually, semi-annually, or bi-annually.

5. The method of claim 1, further comprising:
receiving an input, by the media control device; and
initiating, by the media control device, performance of the method at least once at a time proximate to the receiving the input.

6. The method of claim 2, wherein the media control device is in communication with a network services provider, the method further comprising:
at least one of: generating or updating, by the media control device, a database, the database including one or more entries corresponding to at least some of the one or more digital certificates and at least one of: the first expiration date, the start date, the target date, the certificate name, the first validity time period, the predetermined time period, the model number, the product name, the unique identifier, or the expiration status, wherein the database is located on at least one of: the media control device, or a server device operated by the network services provider.

7. The method of claim 1, the method further comprising:
receiving an input, by the media control device, the input indicating the target date, wherein the predetermined time period is at least one of: a week, a month, three months, six months, nine months, or twelve months.

8. The method of claim 1, wherein the media control device is in communication with a network services provider, and the media control device is a first media control device, the method further comprising:
establishing communication, by the first media control device, with a second media control device, the second media control device being served by the network services provider;
identifying, by the first media control device, a second expiration date in electronic form of at least a second digital certificate of one or more digital certificates related to communication of electronic content via the second media control device;
identifying, by the first media control device, a second validity time period in electronic form of the at least second digital certificate based, at least in part, on a comparison between the second expiration date and the target date;
identifying, by the first media control device, a second expiration status of the at least second digital certificate, the second expiration status being negative upon the second validity time period being greater than the predetermined time period, the second expiration status being positive upon the second validity time period being at least one of: less than, or equal to, the predetermined time period; and
sending, by the first media control device, a second electronic notification indicating at least the second expiration status for the at least second digital certificate at least upon the second expiration status being positive.

9. The method of claim 1, wherein the media control device is at least one of: a set-top box, a home gateway, a mobile device, a media gateway, a television, or a personal computing device.

10. A media control device that provides electronic content, the device comprising:
memory;
a transceiver; and
a processor executing a configuration of the media control device including at least:
identifying a first expiration date in electronic form of at least a first digital certificate of one or more digital certificates related to communication of the electronic content via the media control device;
identifying a first validity time period in electronic form of the least first digital certificate based, at least in part, on a comparison between the first expiration date and a target date;
identifying a first expiration status of the at least first digital certificate, the first expiration status being negative upon the first validity time period being greater than a predetermined time period, the first expiration status being positive upon the first validity time period being at least one of: less than, or equal to, the predetermined time period; and
sending, by the media control device, a first electronic notification indicating at least the first expiration status for the at least first digital certificate at least upon the first expiration status being positive.

11. The device of claim 10, wherein the processor further executes the configuration of the media device including at least:
identifying a start date in electronic form of at least the digital certificate;
identifying a certificate name in electronic form associated with the at least first digital certificate;
identifying at least one of: a model number in electronic form associated with the media control device, or a product name in electronic form associated with the media control device; and
identifying a unique identifier in electronic form associated with the media control device, the processor being further configured such that the first electronic notification further indicates at least one of: the start date, the certificate name, the model number, the product name, or the unique identifier.

12. The device of claim 10, wherein the device is in communication with a network services provider, and the processor sends the first electronic notification to at least one of: a server device operated by the network services provider, or a manufacturer of the media control device.

13. The device of claim 10, wherein the processor automatically executes the configuration of the media control device at least once in a predetermined time frequency, the predetermined time frequency being at least one of: weekly, bi-weekly, monthly, annually, semi-annually, or bi-annually.

14. The device of claim 10, wherein the processor further
receives an input; and
initiates execution of the configuration at least once at a time proximate to the receipt of the input.

15. The device of claim 11, wherein the device is in communication with a network services provider, the processor being further configured to:
at least one of: generate or update, a database, the database including one or more entries corresponding to at least some of the one or more digital certificates and at least one of: the first expiration date, the start date, the target date, the certificate name, the first validity time period, the predetermined time period, the model number, the product name, the unique identifier, or the first expiration status, wherein the database is located on at least one of: the media control device, or a server device operated by the network services provider.

16. The device of claim 10, wherein the processor further
receives an input indicating the target date, the processor being configured such that the predetermined time period is at least one of: a week, a month, three months, six months, nine months, or twelve months.

17. The device of claim 10, wherein the device is in communication with a network services provider, and the media control device is a first media control device, the processor further:
establishes communication with a second media control device, the second media control device being served by the network services provider;
identifies a second expiration date in electronic form of at least a second digital certificate of one or more digital certificates related to communication of electronic content via the second media control device;
identifies a second validity time period in electronic form of the at least second digital certificate based, at least in part, on a comparison between the second expiration date and the target date;
identifies a second expiration status of the at least second digital certificate, the second expiration status being negative upon the second validity time period being greater than the predetermined time period, the second expiration status being positive upon the second validity time period being at least one of: less than, or equal to, the predetermined time period; and
sends a second electronic notification indicating at least the second expiration status for the at least second digital certificate at least upon the second expiration status being positive.

18. The device of claim 10, wherein the device is at least one of: a set-top box, a home gateway, a media gateway, a mobile device, a television, or a personal computing device.

19. A non-transitory computer readable medium having instructions stored thereon, the instructions causing at least one processor of a media control device to perform one or more operations, the media control device being in communication with a network services provider, the one or more operations comprising at least:
identifying a first expiration date in electronic form of at least a first digital certificate of the one or more digital certificates;
identifying a first validity time period in electronic form of the at least first digital certificate based, at least in part, on a comparison between the first expiration date and a target date;
identifying a first expiration status of the at least first digital certificate, the first expiration status being negative upon the first validity time period being greater than a predetermined time period, the first expiration status being positive upon the first validity time period being at least one of: less than, or equal to, the predetermined time period; and
sending a first electronic notification indicating at least the first expiration status for the at least first digital certificate at least upon the first expiration status being positive.

20. The non-transitory computer readable medium of claim 19, wherein the one or more operations further comprise:
identifying a start date in electronic form of the at least first digital certificate;
identifying a certificate name in electronic form associated with at the least first digital certificate;
identifying at least one of: a model number in electronic form associated with the media control device, or a product name in electronic form associated with the media control device; and
identifying a unique identifier in electronic form associated with the media control device, wherein the one or more operations cause the first electronic notification to further indicate at least one of: the start date, the certificate name, the model number, the product name, or the unique identifier.

21. The non-transitory computer readable medium of claim 19, wherein the one or more operations further comprise:
automatically performing the one or more operations at least once in a predetermined time frequency, the predetermined time frequency being at least one of: weekly, bi-weekly, monthly, annually, semi-annually, or bi-annually, the one or more operations causing the first electronic notification to be sent to at least one of: a server device operated by the network services provider, or a manufacturer of the media control device.

22. The non-transitory computer readable medium of claim 19, wherein the one or more operations further comprise:
receiving an input; and
initiating execution of the one or more operations at least once at a time proximate to the receiving the input.

23. The non-transitory computer readable medium of claim 20, wherein the one or more operations further comprise:
at least one of: generating or updating, a database, the database including one or more entries corresponding to at least some of the one or more digital certificates and at least one of: the first expiration date, the start date, the target date, the certificate name, the first validity time period, the predetermined time period, the model number, the product name, the unique identifier, or the first expiration status, wherein the database is located on at least one of: the media control device, or a server device operated by the network services provider.

24. The non-transitory computer readable medium of claim 19, wherein the one or more operations further comprise:
receiving an input indicating the target date, the one or more operations causing the predetermined time period to be at least one of: a week, a month, three months, six months, nine months, or twelve months.

25. The non-transitory computer readable medium of claim 19, wherein the media control device is a first media control device, the one or more operations further comprising:
establishing communication with a second media control device, the second media control device being served by the network services provider;
identifying a second expiration date in electronic form of at least a second digital certificate of one or more digital certificates related to communication of electronic content via the second media control device;
identifying a second validity time period in electronic form of the at least second digital certificate based, at least in part, on a comparison between the second expiration date and the target date;
identifying a second expiration status of the at least second digital certificate, the second expiration status being negative upon the second validity time period being greater than the predetermined time period, the second expiration status being positive upon the second validity time period being at least one of: less than, or equal to, the predetermined time period; and
sending a second electronic notification indicating at least the second expiration status for the at least second digital certificate at least upon the second expiration status being positive.
